(19) United States
(12) Patent Application Publication
(10) Pub. No.: US 2015/0221946 A1
(43) Pub. Date: Aug. 6, 2015

(54) NEGATIVE ELECTRODE FOR NONAQUEOUS ELECTROLYTE SECONDARY BATTERIES, NONAQUEOUS ELECTROLYTE SECONDARY BATTERY, METHOD FOR MANUFACTURING NEGATIVE ELECTRODE FOR NONAQUEOUS ELECTROLYTE SECONDARY BATTERIES, AND METHOD FOR MANUFACTURING NONAQUEOUSELECTROLYTE SECONDARY BATTERY

(71) Applicant: TOYOTA JIDOSHA KABUSHIKI KAISHA, Toyota-shi, Aichi (JP)

(72) Inventor: Koji Takahata, Osaka-shi (JP)

(73) Assignee: TOYOTA JIDOSHA KABUSHIKI KAISHA, Toyota-shi, Aichi (JP)

(21) Appl. No.: 14/419,813

(22) PCT Filed: Apr. 25, 2013
(86) PCT No.: PCT/JP2013/062219

§ 371 Date: Feb. 5, 2015

(30) Foreign Application Priority Data
Aug. 6, 2012 (JP) 2012-174108

(51) Int. Cl. H01M 4/583; H01M 10/0525; H01M 10/04; H01M 4/36

(52) U.S. Cl. CPC H01M 4/583; H01M 4/366; H01M 10/0525; H01M 10/049; H01M 2004/027

(57) ABSTRACT

The present invention provides a negative electrode capable of improving the on-vehicle service life and storage life of a nonaqueous electrolyte secondary battery, a nonaqueous electrolyte secondary battery, and methods for manufacturing them. Provided is a negative electrode (32) used for a lithium-ion secondary battery (1) as a nonaqueous electrolyte secondary battery, including a negative electrode active material made of natural graphite whose surface is coated with amorphous carbon. The negative electrode active material has an electrostatic capacity of not less than 0.122 F/g and not more than 0.160 F/g, and a content percentage of the amorphous carbon of not less than 4 wt % and not more than 7 wt %.

### TECHNICAL FIELD

The present invention relates to a negative electrode for nonaqueous electrolyte secondary batteries which are mounted on vehicles, a nonaqueous electrolyte secondary battery, a method for manufacturing the negative electrode for nonaqueous electrolyte secondary batteries, and a method for manufacturing the nonaqueous electrolyte secondary battery.

### BACKGROUND ART

Conventionally, a nonaqueous electrolyte secondary battery for vehicles, which is mounted on hybrid car or the like, has been known as a nonaqueous electrolyte secondary battery such as a lithium-ion secondary battery.

In this nonaqueous electrolyte secondary battery for vehicles, generally, a paste-like positive electrode mixture obtained by kneading a positive electrode active material, a conductive material, a binding material (binder), a solvent and the like is applied to a current collector for positive electrodes and dried, thereby preparing a positive electrode. In addition, a paste-like negative electrode mixture obtained by kneading a negative electrode active material, a binding material, a thickener, a solvent and the like is applied to a current collector for negative electrodes and dried, thereby preparing a negative electrode.

As the positive electrode active material, “Li (Ni, Mn, Co) O₂-based active material” that is a ternary active material, “lithium iron phosphate (LiFeO₂)” or the like is used. As the negative electrode active material, a graphite-based active material is used.

In the nonaqueous electrolyte secondary battery, generally, a predetermined battery life is required, and further improvement of the battery life is desired.

Patent Literature 1 discloses a lithium-ion secondary battery in which a proper film is formed on a negative electrode, thereby improving a capacity retention rate after a cycle test of repeatedly performing charge and discharge is conducted 500 times.

### CITATION LIST

### Patent Literature

Patent Literature 1: JP 2010-129192 A

### SUMMARY OF INVENTION

### Problems to Be Solved By the Invention

The lithium-ion secondary battery described in Patent Literature 1 is used for consumer products such as mobile phones and notebook personal computers. In the cycle test described in Patent Literature 1, repetition of charge and discharge is performed 500 times in which the battery is charged to 4.2 V at a constant current of 100 mA, then charged at a constant voltage of 4.2 V for 2.5 hours in total, and discharged to 3.0 V at a constant current of 100 mA.

However, nonaqueous electrolyte secondary batteries to be mounted on vehicles are used under conditions different from those for general nonaqueous electrolyte secondary batteries for consumer products, and are therefore required to maintain a capacity retention rate after a charge-discharge cycle test simulating an on-vehicle service life, namely, use on a vehicle is performed.

In the nonaqueous electrolyte secondary battery, it is also important to maintain a storage life (capacity retention rate).

Therefore, the present invention provides a negative electrode capable of improving the on-vehicle service life and storage life of a nonaqueous electrolyte secondary battery, a nonaqueous electrolyte secondary battery, and methods for manufacturing them.

### Means for Solving the Problem

A first aspect of the invention is a negative electrode used for nonaqueous electrolyte secondary batteries, including a negative electrode active material made of natural graphite whose surface is coated with amorphous carbon. The negative electrode active material has an electrostatic capacity of not less than 0.122 F/g and not more than 0.160 F/g, and a content percentage of the amorphous carbon of not less than 4 wt % and not more than 7 wt %.

A second aspect of the invention is a nonaqueous electrolyte secondary battery including the above-mentioned negative electrode.

A third aspect of the invention is a method for manufacturing a negative electrode used for nonaqueous electrolyte secondary batteries, including preparing a negative electrode active material made of natural graphite whose surface is coated with amorphous carbon, the negative electrode active material having an electrostatic capacity of not less than 0.122 F/g and not more than 0.160 F/g, and a content percentage of the amorphous carbon of not less than 4 wt % and not more than 7 wt %, and forming the negative electrode using the negative electrode active material.

A fourth aspect of the invention is a method for manufacturing a nonaqueous electrolyte secondary battery, including forming the nonaqueous electrolyte secondary battery using the negative electrode manufactured by the above-mentioned method.

### Effects of the Invention

The present invention makes it possible to improve the on-vehicle service life and storage life of a nonaqueous electrolyte secondary battery.

### BRIEF DESCRIPTION OF DRAWINGS

FIG. 1 is a side view showing a lithium-ion secondary battery.

FIG. 2 shows a relationship between a capacity retention rate of the lithium-ion secondary battery after performing a low-temperature pulse test, and an electrostatic capacity of a negative active material and coating amount of amorphous carbon in the lithium-ion secondary battery.

FIG. 3 shows a relationship between the capacity retention rate of the lithium-ion secondary battery after performing a preservation test, and the electrostatic capacity of a negative active material and coating amount of amorphous carbon in the lithium-ion

### DESCRIPTION OF EMBODIMENTS

An embodiment for carrying out the present invention is described with reference to the attached drawings.

As shown in FIG. 1, a lithium-ion secondary battery 1 as a nonaqueous electrolyte secondary battery according to the present embodiment is formed by storing an electrode body 3 together with an electrolyte solution into a battery case 2 including a bottomed rectangular cylinder-shaped case body 21 of which one surface (upper face) is opened, and a lid 22 which is formed in a flat plate and closes the opening of the case body 21.

The battery case 2 is a prismatic case with the opening of the case body 21 closed by the flat plate-shaped lid 22, the case body 21 being formed in a bottomed rectangular cylinder in the shape of a rectangular parallelepiped, of which one surface (upper face) is opened.

A positive electrode terminal 4a is provided at one end portion of the lid 22 in the longitudinal direction (left end portion in FIG. 1), and a negative electrode terminal 4b is provided at the other end portion of the lid 22 in the longitudinal direction (right end portion in FIG. 1).

The electrode body 3 is formed in the following manner: a positive electrode 31, a negative electrode 32 and a separator are laminated so that the separator is interposed between the positive electrode 31 and the negative electrode 32, and the laminated positive electrode 31, negative electrode 32 and separator are wound and formed into a flat shape.

For forming the lithium-ion secondary battery 1 by storing the electrode body 3 and the electrolyte solution into the battery case 2, first, the positive electrode terminal 4a and the negative electrode terminal 4b of the lid 22 are connected to the positive electrode 31 and the negative electrode 32 of the electrode body 3, respectively, and the electrode body 3 is attached to the lid 22 to form a lid sub-assembly.

Then, the electrode body 3 and the electrolyte solution are stored in the case body 21, the lid 22 and the case body 21 are tightly sealed together by welding while fitting the lid 22 into the opening of the case body 21. Thereby, the lithium-ion secondary battery 1 is formed.

The positive electrode 31 is prepared in the following manner: a paste-like positive electrode mixture obtained by kneading electrode materials such as a positive electrode active material, a conductive material and a binding material together with a solvent is applied to the surface (one surface or both surfaces) of a positive electrode current collector formed in a sheet, and the applied positive electrode mixture is dried and pressed. The positive electrode 31 has a positive electrode mixture layer formed on the surface of the positive electrode current collector.

As the positive electrode active material, (Li (Ni, Mn, Co) O₂-based active material) that is a ternary active material, (lithium iron phosphate (LiFeO₂)) or the like can be used.

The negative electrode 32 is also prepared in the following manner: a paste-like negative electrode mixture obtained by kneading electrode materials such as a negative electrode active material, a thickener and a binding material together with a solvent is applied to the surface (one surface or both surfaces) of a negative electrode current collector formed in a sheet, and the applied negative electrode mixture is dried and pressed. The negative electrode 32 has a negative electrode mixture layer formed on the surface of the negative electrode current collector.

As the negative electrode active material, a natural graphite-based active material can be used.

The separator is a sheet-like member made of, for example, a porous polyolefin-based resin, and is arranged between the positive electrode 31 and the negative electrode 32.

In the lithium-ion secondary battery 1 in the present embodiment, natural graphite whose surface is coated with amorphous carbon is used as the negative electrode active material contained in the negative electrode mixture.

The coating amount of amorphous carbon of natural graphite in the negative electrode active material, namely, the content percentage of the amorphous carbon in the negative electrode active material is set to be not less than 4 wt % and not more than 7 wt %.

Natural graphite whose surface coated with amorphous carbon is obtained by, for example, covering the surface of natural graphite with a pitch made from petroleum residues, and heating the natural graphite at approximately 1000° C.

The negative electrode active material having an electrostatic capacity (capacitance) of not less than 0.122 F/g and not more than 0.160 F/g is used.

The electrostatic capacity of the negative electrode active material serves as an index indicating a reaction area of the negative electrode 32, and when the electrostatic capacity of the negative electrode active material is increased, Li acceptability of the negative electrode 32 can be improved.

For example, the electrostatic capacity of the negative electrode active material may be found in the following manner.

A pair of sample pieces in each of which a negative electrode mixture layer formed on one surface of a negative electrode current collector are disposed at a predetermined distance so that the negative electrode mixture layers face each other, and the gap between the sample pieces is filled with the electrolyte solution of the lithium-ion secondary battery 1. In this state, impedance between the sample pieces is measured, and an electrostatic capacity can be calculated from the measured impedance using a Cole-Cole plot.

When the negative electrode 32 of the lithium-ion secondary battery 1 is configured as mentioned above, the on-vehicle service life (capacity retention rate) and storage life (capacity retention rate) of the lithium-ion secondary battery 1 can be improved.

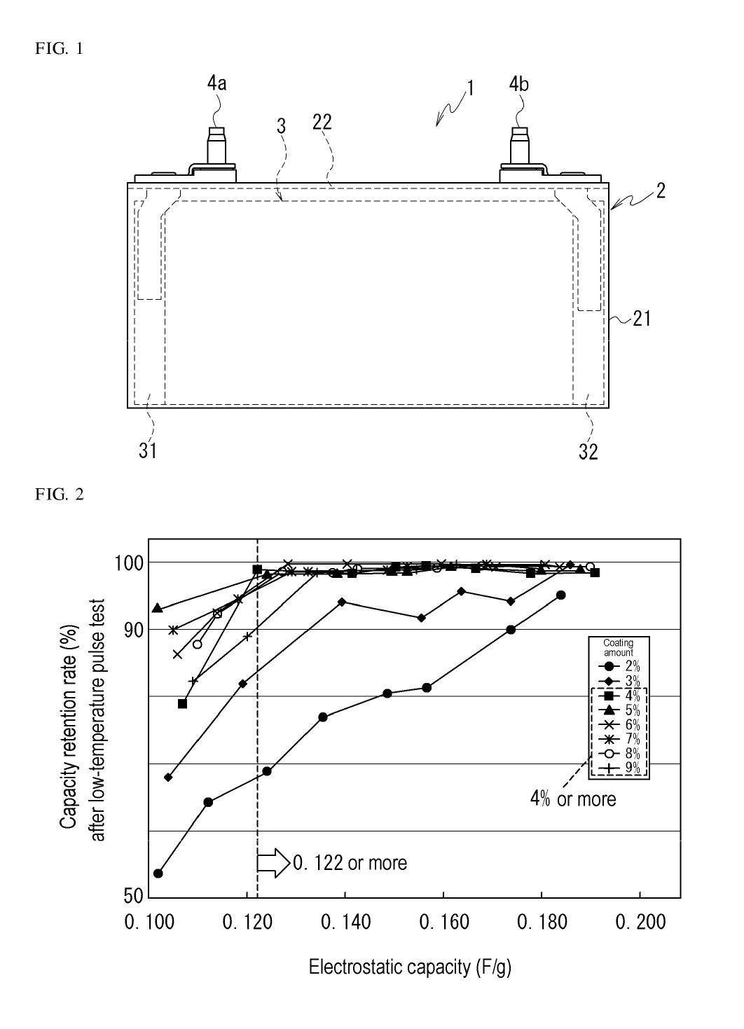

FIG. 2 shows a relationship between the capacity retention rate of the lithium-ion secondary battery 1 after performing a charge-discharge cycle test simulating use on a vehicle, and the electrostatic capacity of the negative electrode active material.

In the above-mentioned charge-discharge cycle test simulating use on a vehicle, a step for subjecting the lithium-ion secondary battery 1 to pulse-charge for 10 seconds, and to pulse-discharge for 10 seconds 10 minutes after the pulse-charge is defined as one cycle, and this cycle is repeatedly performed.

The charge-discharge cycle test is performed under an environment at a low temperature (0° C.), and charge and discharge are performed at 30 C. Hereinafter, the charge-discharge cycle test performed under an environment at a low temperature (0° C.) is appropriately referred to as a “low-temperature pulse test”.

FIG. 2 shows that the capacity retention rate of the lithium-ion secondary battery 1 after the low-temperature pulse test rises as the coating amount of amorphous carbon of natural graphite (content percentage of amorphous carbon in the negative electrode active material) increases. Moreover, the capacity retention rate of the lithium-ion secondary battery 1 after the low-temperature pulse test rises as the electrostatic capacity of the negative electrode active material increases.

When the content percentage of amorphous carbon in the negative electrode active material is 4% or more, and the electrostatic capacity of the negative electrode active material is 0.122 F/g or more, the lithium-ion secondary battery 1 exhibits a good capacity retention rate of 98% or more after the low-temperature pulse test.

When the content percentage of amorphous carbon in the negative electrode active material is less than 4%, or the electrostatic capacity of the negative electrode active material is less than 0.122 F/g, the capacity retention rate of the lithium-ion secondary battery 1 after the low-temperature pulse test decreases. This may be ascribable to precipitation of Li from the negative electrode active material.

Therefore, when the content percentage of amorphous carbon in the negative electrode active material is 4% or more, and the electrostatic capacity of the negative electrode active material is 0.122 F/g or more, precipitation of Li from the negative electrode active material can be suppressed to maintain the capacity retention rate of the lithium-ion secondary battery 1.

Thus, the negative electrode 32 is formed using a negative electrode active material having a content percentage of amorphous carbon of 4% or more and an electrostatic capacity of 0.122 F/g or more, which makes it possible to form the lithium-ion secondary battery 1 excellent in capacity retention rate after the charge-discharge cycle test (low-temperature pulse test) simulating use on a vehicle, and consequently to improve the on-vehicle service life of the lithium-ion secondary battery 1.

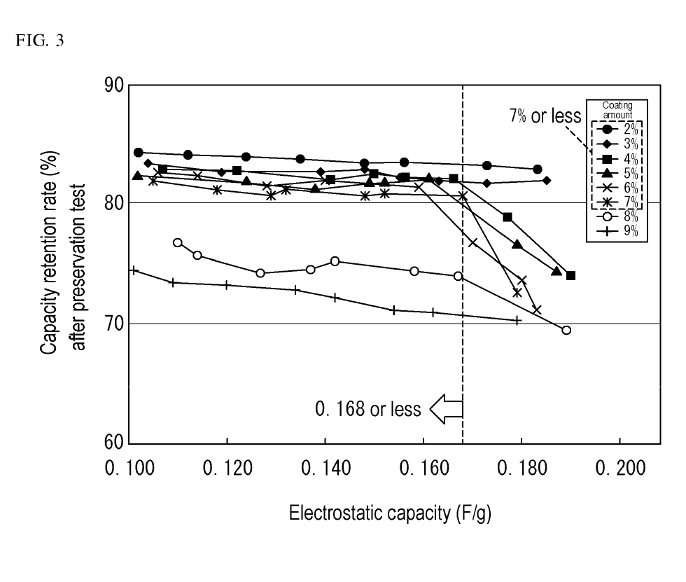

FIG. 3 shows a relationship between the capacity retention rate of the lithium-ion secondary battery 1 after performing a preservation test, and the electrostatic capacity of the negative electrode active material.

In the preservation test, the lithium-ion secondary battery 1 with a state of charge (SOC) of 85% is allowed to stand under an environment of 60° C. for 90 days.

FIG. 3 shows that the capacity retention rate of the lithium-ion secondary battery 1 after the preservation test decreases as the coating amount of amorphous carbon of natural graphite (content percentage of amorphous carbon in the negative electrode active material) increases, and particularly the capacity retention rate markedly decreases when the content percentage of amorphous carbon in the negative electrode active material is 8% or more. Moreover, the capacity retention rate of the lithium-ion secondary battery 1 after the preservation test decreases as the electrostatic capacity of the negative electrode active material increases, and particularly the capacity retention rate markedly decreases when the electrostatic capacity of the negative electrode active material exceeds 0.168 F/g.

On the other hand, when the content percentage of amorphous carbon in the negative electrode active material is 7% or less, and the electrostatic capacity of the negative electrode active material is 0.168 F/g or less, the lithium-ion secondary battery 1 maintains a capacity retention rate of 80% or more after the preservation test.

As mentioned previously, when the content percentage of amorphous carbon in the negative electrode active material increases to 8% or more, the capacity retention rate of the lithium-ion secondary battery 1 considerably decreases. This may be because a solid electrolyte interface (SEI) film formed on the surface of the negative electrode 32 by a chemical reaction of Li ions with the electrolyte solution becomes thick, and thereby the amount of Li ions captured in the SEI film increases.

Therefore, when the content percentage of amorphous carbon in the negative electrode active material is 7% or less, the amount of Li ions captured in the SEI film can be reduced to maintain the capacity retention rate of the lithium-ion secondary battery 1.

Thus, the negative electrode 32 is formed using a negative electrode active material having a content percentage of amorphous carbon of 7% or less and an electrostatic capacity of 0.168 F/g or less, which makes it possible to form the lithium-ion secondary battery 1 excellent in capacity retention rate after the preservation test, and consequently to improve the storage life of the lithium-ion secondary battery 1.

Accordingly, the negative electrode 32 is formed using a negative electrode active material made of natural graphite whose surface is coated with amorphous carbon, which has an electrostatic capacity of not less than 0.122 F/g and not more than 0.160 F/g, and which has a content percentage of amorphous carbon of not less than 4 wt % and not more than 7 wt %. This makes it possible to form lithium-ion secondary battery 1 whose on-vehicle service life and storage life are improved.

### INDUSTRIAL APPLICABILITY

The present invention may be applied to a negative electrode for nonaqueous electrolyte secondary batteries which are mounted on vehicles, a nonaqueous electrolyte secondary battery, a method for manufacturing the negative electrode for nonaqueous electrolyte secondary batteries, and a method for manufacturing the nonaqueous electrolyte secondary battery.

### REFERENCE SIGNS LIST

1: lithium-ion secondary battery

2: battery case

3: electrode body

31: positive electrode

32: negative electrode

1. A negative electrode used for nonaqueous electrolyte secondary batteries, comprising:
a negative electrode active material made of natural graphite whose surface is coated with amorphous carbon, wherein the negative electrode active material has an electrostatic capacity of not less than 0.122 F/g and not more than 0.160 F/g, and
the negative electrode active material has a content percentage of the amorphous carbon of not less than 4 wt % and not more than 7 wt %.

2. A nonaqueous electrolyte secondary battery comprising the negative electrode according to claim 1.

3. A method for manufacturing a negative electrode used for nonaqueous electrolyte secondary batteries, comprising:
preparing a negative electrode active material made of natural graphite whose surface is coated with amorphous carbon, the negative electrode active material having an electrostatic capacity of not less than 0.122 F/g and not more than 0.160 F/g, and a content percentage of the amorphous carbon of not less than 4 wt % and not more than 7 wt %, and
forming the negative electrode using the negative electrode active material.

4. A method for manufacturing a nonaqueous electrolyte secondary battery, comprising:
forming the nonaqueous electrolyte secondary battery using the negative electrode manufactured by the method according to claim 3.
